(19) United States
(12) Patent Application Publication
(10) Pub. No.: US 2020/0141965 A1
(43) Pub. Date: May 7, 2020

(54) HORIZONTAL ACOUSTIC SEDIMENT AND CURRENT PROFILER APPARATUS AND METHODS

(71) Applicant: Rowe Technologies, Inc., Poway, CA (US)

(72) Inventors: Sairajan Sarangpani, Poway, CA (US); Francis Dale Rowe, Poway, CA (US)

(21) Appl. No.: 16/677,555

(22) Filed: Nov. 7, 2019

Related U.S. Application Data
(60) Provisional application No. 62/757,019, filed on Nov. 7, 2018.

(51) Int. Cl. G01P 5/24; G01S 15/58; G01S 15/89; G01S 7/536

(52) U.S. Cl. CPC G01P 5/241; G01S 7/536; G01S 15/8959; G01S 15/582

(57) ABSTRACT

A horizontal acoustic sediment and current profiler and methods of use. In one implementation, the horizontal acoustic sediment and current profiler includes a housing that is configured to house a plurality of transducer elements. In some implementations, these plurality of transducer elements include a plurality of rectangular transducer elements that are each configured to form a beam having a beam width of less than one degree; a first transducer element that is configured to form a first beam at a first frequency; a second transducer element that is configured to form a second beam at a second frequency, the second frequency differing from the first frequency; and a vertical transducer element that is oriented substantially orthogonal to the first transducer element and the second transducer element, the vertical transducer element configured to measure a depth of placement of the horizontal acoustic sediment and current profiler with respect to a surface of a fluidic medium.

### PRIORITY AND RELATED APPLICATIONS

This application claims the benefit of priority to co-owned U.S. Provisional Patent Application Ser. No. 62/757,019 entitled “HORIZONTAL ACOUSTIC SEDIMENT AND CURRENT PROFILER” filed Nov. 7, 2018, which is incorporated herein by reference in its entirety.

This application is also generally related to the subject matter of co-owned and co-pending U.S. patent application Ser. No. 16/292,069 filed Mar. 4, 2019 and entitled “HYBRID TRANSDUCER APPARATUS AND METHODS OF MANUFACTURE AND USE”; Ser. No. 16/131,970 filed Sep. 14, 2018 entitled “MULTI-FREQUENCY PISTON TRANSDUCER”, Ser. No. 13/773,447 filed Feb. 21, 2013 and entitled “ACQUATIC VELOCITY SCANNING APPARATUS AND METHODS”, Ser. No. 14/460,853 filed Aug. 15, 2014 and entitled “SUB-ARRAY TRANSDUCER APPARATUS AND METHODS”, and Ser. No. 13/282,257 filed Oct. 26, 2011 end entitled “MULTI FREQUENCY 2D PHASED ARRAY TRANSDUCER”, each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNOLOGICAL FIELD

The present disclosure relates to a transducer apparatus, and in one exemplary implementation, to a transducer apparatus and associated methods for the measurement of higher quality river flow velocity index, current profiles and/or sediment, and particle size distribution using multiple frequencies in a single acoustic system.

### BACKGROUND OF THE INVENTION

Acoustic Doppler current profilers (ADCPs) are instruments that are generally used to measure, among other things, velocity, direction, depth, and/or distance of water currents in a body of water. For example, an ADCP anchored to the seafloor can measure the speed of water current at the bottom of the water as well as currents or portions between the floor and the surface of the water. An ADCP may be anchored at different depths (e.g., along a column), mounted onto ships (e.g., bottom of the ship) or other types of vessels, or submerged lower by a cable for deep waters.

As the name suggests, ADCPs utilize the so-called Doppler effect to accomplish the above. Sound waves that reflect back from an object moving away from the source have a lower frequency when they return (observed frequency f<emitted frequency f₀). In contrast, sound waves that reflect back from an object moving toward the source send back waves that have a higher frequency (f>f₀). Transmitted and received frequencies are equal or substantially equal where the object is stationary or moving normal to the direction of the sound wave. The difference in frequency, i.e., the Doppler frequency shift, allows a profiling instrument to determine e.g., how fast the object is moving. An ADCP may determine how fast the water is moving by reflecting sound waves from particles in the water and detecting any Doppler shifts that happen based on the sound waves generated by the ADCP.

Consistent precision and accuracy are important when measuring in a medium such as water that is constantly in movement. While compromises in acoustic frequencies may be made to obtain satisfactory measurements (e.g., to adjust acoustic range), there is a need for more accurate measurements, particularly when using an ADCP or similar instrument for determining the mass and distribution of particles such as sediment in the water.

### SUMMARY

The present disclosure addresses the foregoing needs by providing improved acoustic sediment and/or current profiler apparatus and methods of use.

In one aspect of the present disclosure, an acoustic profiler apparatus is disclosed. In one embodiment, the apparatus includes an acoustic sediment current profile apparatus (ASCP) configured to generate a plurality of acoustic beams of different frequencies in a prescribed spatial relationship so as to enable accurate sediment and current flow profiling within fluidic mediums such as rivers. In one variant, the apparatus includes transducers operative to emit acoustic frequencies on the order of 600 kHz, 1200 kHz, and 2400 kHz, with each of the beams directed in different azimuth and/or elevation.

In another variant, the apparatus includes a linear receiver for performance of echo intensity measurements while in situ. In one implementation, the echo intensity measurements are based on broadband signals.

In yet another variant, the apparatus includes a continuous data quality and built-in-test (BIT) functional module for performance assessment and testing of the apparatus transducer and electronics modules to generate inter alia, real time operational data and status, plus fault localization to field-replaceable modules.

In another aspect, an acoustic profiling apparatus for use in a fluidic medium is disclosed. In one embodiment, the apparatus includes: at least one first transducer element configured to operate within a first frequency band; at least one second transducer element configured to operate within a second frequency band different than the first frequency band; and transmit/receive circuitry in signal communication with the at least one first transducer element and the at least one second transducer element and configured to (i) cause emission of at least a first acoustic beam from the at least one first transducer element and at least a second acoustic beam for the at least one second transducer element; and (ii) enable reception of echoes via at least one of the at least one first and at least one second transducer elements; and computerized logic in communication with the transmit/receive circuitry.

In one variant, the computerized logic is configured to: determine at least a Doppler frequency shift and an echo intensity relating to each of the acoustic beams; and compute at least one profile of at least one of parameter related to sediment in the fluidic medium.

In one implementation, the computerized logic is further configured to: determine at least one echo frequency distribution from one or more broadband transmissions centered at each of the first and second frequency bands; and process the at least one echo frequency distribution from one or more broadband transmissions centered at each of the first and second frequency bands to enable determination of at least one of a particle size distribution or sediment mass. In one configuration, the one or more broadband transmissions each comprise a bandwidth less than 50% of a nominal transmit frequency of the respective first and second frequency bands.

In another variant, the acoustic profiling apparatus further includes at least one third transducer element, wherein the at least one third transducer element is configured to operate within a third frequency band, the third frequency band different than the first and second frequency bands. For example, the first frequency band includes a frequency band centered at approximately 600 kHz and the second frequency band includes a frequency band centered at approximately 1200 kHz, and the third frequency band includes a frequency band centered at approximately 2400 kHz.

In another variant, the first frequency band includes a frequency band centered at approximately 600 kHz and the second frequency band includes a frequency band centered at approximately 1200 kHz, and the at least one first transducer element includes two transducer elements configured to generate respective first and second beams disposed at a prescribed azimuth angle to one another, the respective beams being orthogonal to the at least one acoustic beam of the at least one second transducer element.

In one implementation thereof, the generated respective first and second beams disposed at a prescribed azimuth angle to one another comprise first and second beams each having an angular dispersion of approximately 1.5 degrees and a beam centerline oriented substantially normal to a front face of a housing of the acoustic profiling apparatus, and the at least one acoustic beam of the at least one second transducer element includes a beam having an angular dispersion other than 1.5 degrees and a beam centerline oriented substantially normal to a top face of a housing of the acoustic profiling apparatus.

In one configuration, the acoustic profiling apparatus is configured to measure at least one or horizontal currents or sediment mass in the fluidic medium, and the front face of a housing of the acoustic profiling apparatus is configured to be disposed substantially parallel to a plane of a surface of the fluidic medium.

In another variant, the at least one first transducer elements each comprise piston-type transducer elements having a first face diameter, and the at least one second transducer element includes a piston-type transducer element having a second face diameter smaller than the first diameter.

Alternatively, in another variant, the at least one first transducer elements each comprise at least approximately rectangular transducer elements, and the at least one second transducer element includes a piston-type transducer element having an at least approximately circular face.

In another aspect, a horizontal acoustic profiler apparatus configured to profile a at least one aspect of a body of water is disclosed and includes in one embodiment: a single housing configured to operate within a fluidic medium, the single housing comprising: a first transducer element configured to form a first acoustic beam oriented in a first direction, the first acoustic beam being associated with a first frequency; a second transducer elements configured to form a second acoustic beam oriented in a second direction, the second acoustic beam being associated with a second frequency, the second frequency differing from the first frequency, a third transducer element configured to form a third acoustic beam oriented in a third direction, the third acoustic beam being associated with a third frequency, the third direction being substantially orthogonal to both the first direction and the second direction; circuitry in signal communication with the first, second and third transducer elements and configured to generate at least the first, second, and third acoustic beams; and computerized logic in communication with the circuitry and configured to perform Doppler analysis of a plurality of echoes received via the first, second and third transducer elements to enable the horizontal acoustic profiler apparatus to determine both (i) surface height of the body of water relative thereto, and (ii) horizontal current profiles within the body of water.

In one variant, the apparatus further includes at least one pressure sensor configured to generate pressure signals to be used as part of said surface height determination. The apparatus may also include (i) at least one electrical power interface configured to enable powering of the horizontal acoustic profiler apparatus from a remote power source located above the surface of the body of water during operation, and (ii) at least one temperature sensor configured to generate signals related to temperature of water proximate to the horizontal acoustic profiler apparatus to be used as part of a determination by said computerized logic of a speed of sound in the body of water; (iii) at least one pitch/roll sensor configured to generate signals related to an attitude of the horizontal acoustic profiler apparatus relative to a local gravitational field; and (iv) at least one electronic compass apparatus configured to determine at least one azimuth orientation of the horizontal acoustic profiler apparatus.

In another aspect, a method of operating an acoustic apparatus is disclosed. In one embodiment, the method includes: using multiple acoustic frequencies, creating multiple acoustic beams; and processing both Doppler frequency shift and echo intensity from each of the beams operated at different frequencies to compute one or more profiles of at least one of currents, particle size distribution and/or sediment mass.

In another embodiment, the method includes calculation of an echo frequency distribution from broadband transmissions (e.g., up to 50% of nominal transmit frequency) at each of the multiple operating frequencies; the echo distributions are processed and combined to enable determination of particle size distribution and sediment mass.

In another aspect, a method of operating an underwater acoustic apparatus having at least first and second acoustic transducers configured to generate acoustic beams at respective ones of first and second frequencies when disposed in a body of water is disclosed. In one embodiment, the method includes: generating at least a first acoustic beam at the first frequency from at least the first acoustic transducer; generating at least a second acoustic beam at a second frequency from at least the second acoustic transducer; determining a Doppler frequency shift associated with echoes received by the acoustic apparatus relating to the first acoustic beam; determining a Doppler frequency shift associated with echoes received by the acoustic apparatus relating to the second acoustic beam; determining an intensity or level of the echoes received by the acoustic apparatus relating to the first acoustic beam; determining an intensity or level of the echoes received by the acoustic apparatus relating to the second acoustic beam; and based at least on (i) the determined Doppler frequency shifts associated with the echoes relating to the first and second acoustic beams, and (ii) the determined intensity or level of the echoes relating to the first and second acoustic beams, determining at least one profile of at least a portion of the body of water.

In one variant, the method further includes: generating at least one first broadband acoustic transmission within a first frequency band, the first frequency band encompassing the first frequency; generating at least one second broadband acoustic transmission within a second frequency band, the second frequency band encompassing the second frequency; and calculating at least one echo frequency distribution based at least on the at least one first broadband acoustic transmission and the at least one second broadband acoustic transmission; and utilizing the at least one echo distribution to determine at least one of a sediment particle size distribution or a sediment mass.

In another variant, the calculating at least one echo frequency distribution based at least on the at least one first broadband acoustic transmission and the at least one second broadband acoustic transmission includes: (i) calculating at least a first echo frequency distribution based at least on the at least one first broadband acoustic transmission, and (ii) calculating at least a second echo frequency distribution based at least on the at least one second broadband acoustic transmission, and the utilizing the at least one echo distribution to determine at least one of a sediment particle size distribution or a sediment mass includes algorithmically combining the at least first echo distribution and the at least second echo distribution.

In a further aspect, a computer readable apparatus is disclosed. In one embodiment, the apparatus includes a storage medium with at least one computer program disposed thereon. In one variant, the at least one computer program includes HASCP programming software configured to enable user operation setup, data collection and initial real-time sediment characterization.

In another aspect, a transducer module apparatus is disclosed. In one embodiment, the transducer module apparatus is configured to be a replaceable submodule of the HASCP apparatus, and includes “snap in/out” functionality including electrical connections (which are sealed so as to be water-tight). In one implementation, sub-modules of different capabilities can be substituted into the housing of the HASCP apparatus, so as to enable field-reconfiguration of the system.

In a further aspect, a HASCP reconfigurable housing is disclosed. In one embodiment, the housing may be reconfigured with different functional modules on each of a plurality of faces or facets thereof, including selection of different transducer packages (and associated operating frequencies, dispersion, etc.).

In another aspect, a system is disclosed. In one embodiment, the system includes a horizontal acoustic sediment current profile (HASCP) apparatus and one or more platforms supporting the HASCP apparatus for use in the aforementioned fluidic or aquatic environment. In one variant, the one or more platforms are stationary. In another variant, the one or more platforms are fixed, yet allow the HASCP to change position in at least one Cartesian dimension (correlated to e.g., depth and/or river/channel position). In yet another variant, the one or more platforms comprise a mobile platform such as a ship or barge.

### BRIEF DESCRIPTION OF THE DRAWINGS

The features, objectives, and advantages of the disclosure will become more apparent from the detailed description set forth below when taken in conjunction with the drawings, wherein:

FIG. 1A is a perspective view of a typical prior art bottom-sitting acoustic profiler apparatus.

FIG. 1B is a graphical illustration of a prior art approach to horizontal acoustic profiling of a body of water such as a river.

FIG. 2 is a perspective view one exemplary embodiment of a horizontal acoustic sediment and current profiler (HASCP) apparatus, in accordance with the principles of the present disclosure.

FIGS. 2A-2C are top elevation views of various exemplary alternate combinations of beam directions formed by the various transducer elements of the apparatus of FIG. 2, including symmetric and asymmetric azimuth configurations.

FIG. 2D is a side elevation view of an exemplary alternate combinations of beam directions formed by the various transducer elements, including symmetric and asymmetric elevation configurations.

FIG. 2E is an illustration of one exemplary usage scenario for the HASCP apparatus of FIG. 2 shown exemplary acoustic beams formed thereby, in accordance with the principles of the present disclosure.

FIG. 2F is a three-dimensional plot of an exemplary sediment particulate distribution obtained using the acoustic profiling apparatus of the present disclosure.

FIG. 3 is a front perspective view of another embodiment of the HASCP apparatus of the present disclosure.

FIG. 3A is a composite front, top and side elevation view of the HASCP apparatus of FIG. 3, showing exemplary dimensions and features thereof.

FIGS. 3B-3D illustrate various embodiments of multi-HASCP array apparatus according to the present disclosure.

FIG. 4 is a logical flowchart illustrating an exemplary embodiment of a method for profiling one or more water currents according to the present disclosure.

FIG. 4A is a logical flowchart illustrating an exemplary embodiment of a method of operating a current profiler apparatus according to the present disclosure.

FIG. 4B is a logical flowchart illustrating another exemplary embodiment of operating a current profiler apparatus according to the present disclosure.

FIG. 4C is a logical flowchart illustrating yet another exemplary embodiment of a method of operating a current profiler apparatus according to the present disclosure.

FIG. 5 is a functional block diagram of an exemplary embodiment of the horizontal acoustic sediment/current profiler (HASCP) apparatus of the present disclosure.

All Figures disclosed herein are © Copyright 2018-2019 Rowe Technologies, Inc. All rights reserved.

### DETAILED DESCRIPTION OF EXEMPLARY EMBODIMENTS

Detailed descriptions of the various embodiments and variants of the apparatus and methods of the disclosure are now provided. While primarily discussed in the context of Horizontal Acoustic Sediment and/or Current Profiler (HASCP) applications, the various apparatus and methodologies discussed herein are not so limited. In fact, many of the apparatus and methodologies described herein are useful in sonar applications where diverse operating frequencies are advantageous, and where multiple transducer apertures and orientations are also important. For example, the HASCP apparatus disclosed herein may be utilized in determining zooplankton size and distribution of other particles, fish finders, Doppler velocity logs used for navigation and other suitable types of sonar applications.

Furthermore, while primarily discussed in the context of a HASCP transducer having five distinct transducer surfaces operating at a total of three different frequency bands, it is appreciated that additional transducer surfaces (i.e. six (6) or more) or fewer transducer surfaces (i.e., four (4) or fewer) could be embodied within a single HASCP transducer apparatus in accordance with embodiments of the present disclosure. It can be readily recognized by one of ordinary skill, given the present disclosure that many of the features described herein possess broader usefulness outside of the specific examples and implementations with which they are described.

### Existing Acoustic Profilers—

Sonar transducers are used in different types of acoustic backscatter systems that measure velocity and/or distance along narrow acoustic beams. A class of these sonars employs single or multiple circular “piston” transducers or rectangular plate transducers where each piston transducer produces a single narrow acoustic radiating normal to the transducer face.

One type of sonar system in which the foregoing transducers are used is the ADCP (acoustic Doppler current profiler), which are well-known systems for measuring current velocities using broadband acoustic signals. See e.g., U.S. Pat. No. 5,615,173 entitled “BROADBAND ACOUSTIC DOPPLER CURRENT PROFILER” and granted on Mar. 25, 1997 to Brumley et al., incorporated herein by reference in its entirety for one exemplary configuration of an ADCP.

ADCPs in current use may make various measurements of water current velocities, direction of water currents, distance to objects and water surfaces, wave heights (difference between crest and trough, or top and bottom of waves), etc. Piezoelectric transducers on an ADCP transmit and receive signals as sound waves to, e.g., estimate distance. To measure velocities in two dimensions, two or more beams are used. To measure velocities in three dimensions, three or more beams are used. More beams may be utilized to measure other properties of the current, such as turbulence.

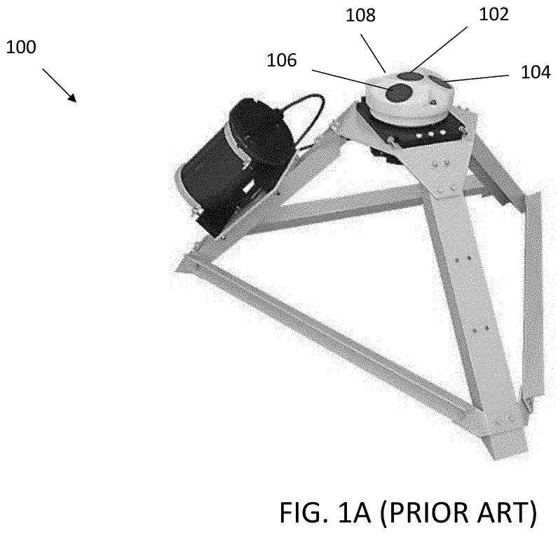

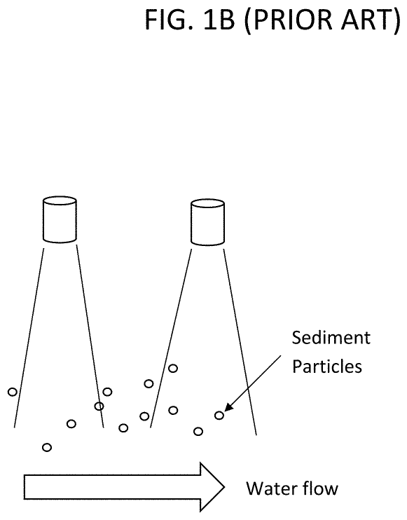

FIG. 1A illustrates an example of a currently used ADCP 100, specifically an Acoustic Wave and Currents (AWAC) type that is configured to measure surface wave height and direction. Each of the transducers 102, 104, 106 of the ADCP 100 may produce pulses of sound waves, the pulses from a respective transducer forming a beam in the direction normal to the surface of the transducer. An additional transducer 108 (not shown) may also be included depending on the application of the AWAC. Vertical beams generated by the ADCP 100 may measure, e.g., the wave height or distance to surface, using, e.g., travel times of the pulses. Notably, the transducers of the illustrated ADCP 100 are all pointed in a substantially similar direction, e.g., in a generally vertical direction toward a surface of water.

The term “vertical” as used herein may refer to a direction generally normal to a surface of a fluid being measured such as water, or generally perpendicular to sea level. The term “horizontal” as used herein may refer to a direction generally parallel to a surface of a body of water.

### Horizontal Acoustic Sediment and Current Profiler and Beam Frequency Configurations—

Another type of ADCP is the H-ADCP (Horizontal Acoustic Doppler Current Profiler), wherein acoustic beams are used to measure the velocity horizontal profile across a channel by its two horizontal acoustic beams and measures depth of the water column with an additional up-looking acoustic beam. The information from the H-ADCP is also used for measuring the discharge across the river. The H-ADCP is usually mounted in the mid water column on the rivers side and provide time series measurements of horizontal across-stream profiles of downstream currents and estimates of mass sediment. For measuring the sediment and particle size distribution, high frequency sonars are often required with narrow beam width and two or more high frequency sonars are used for the measurement. A factor of 2-3 differences in octave of frequency is used by the sonars for the sediment and particle size distribution. The current and mass sediment measurements are made on many of the world's rivers and these H-ADCPs typically operate at a single fixed acoustic frequency for all beams in the range of 300-4000 kHz.

FIG. 1B is a graphical illustration of one such prior art approach to horizontal acoustic profiling of a body of water such as a river.

The echo from the river sediment varies as a function of the operational frequency of the instrument, and typically the echo magnitude increases as a function of the frequency (because of higher backscatter echoes from smaller particles at higher acoustic frequencies). Thus, sediment mass is generally a somewhat rough estimate, because the particle size distribution varies with time, vertical and horizontal location in the river, and individual rivers.

However, it has been recognized by the Assignee hereof that instruments operating at different (e.g., two or more) frequencies may be utilized to provide additional useful information. For example, analysis of echo amplitude profiles derived from multiple frequency instruments can be used to calculate sediment particle size distribution profiles, and the accuracy of calculated sediment mass profiles can be improved.

The present disclosure is, in one exemplary implementation, directed towards a single acoustic sediment/current profiler (ASCP) which employs multiple acoustic frequencies, creating multiple acoustic beams, and processing both Doppler frequency shift and echo intensity from each of the beams operated at different frequencies to compute profiles of currents, particle size distribution and sediment mass. The multiple acoustic beams employed by the system may be pointed toward different directions (both in azimuth and elevation in some embodiments), for example, vertically and horizontally. Additionally, calculation of the echo frequency distribution from broadband transmissions (up to 50% of nominal transmit frequency) at each of the multiple operating frequencies are processed and combined to determine particle size distribution and sediment mass.

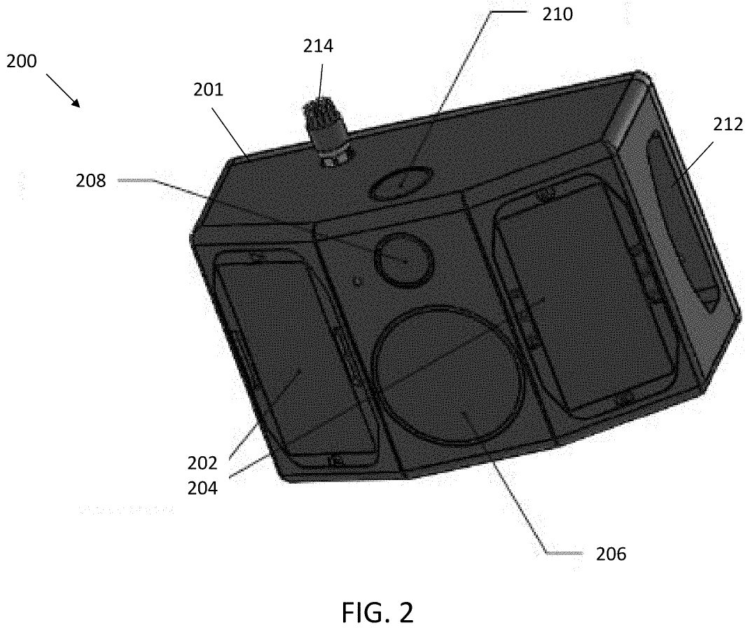

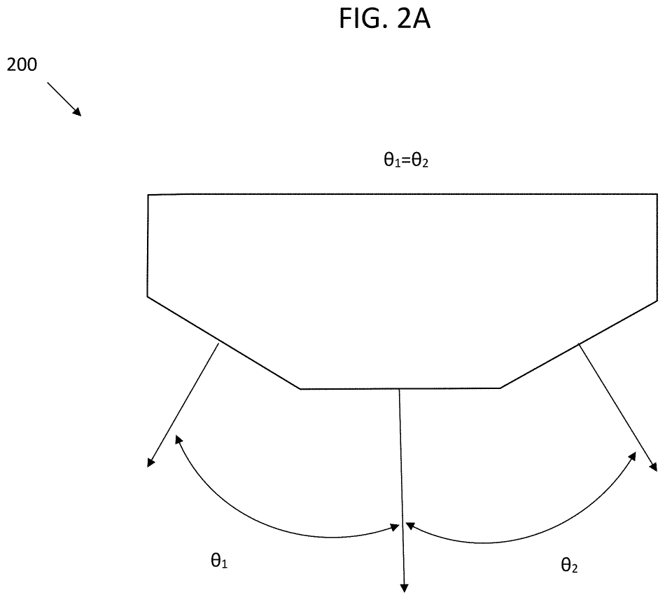

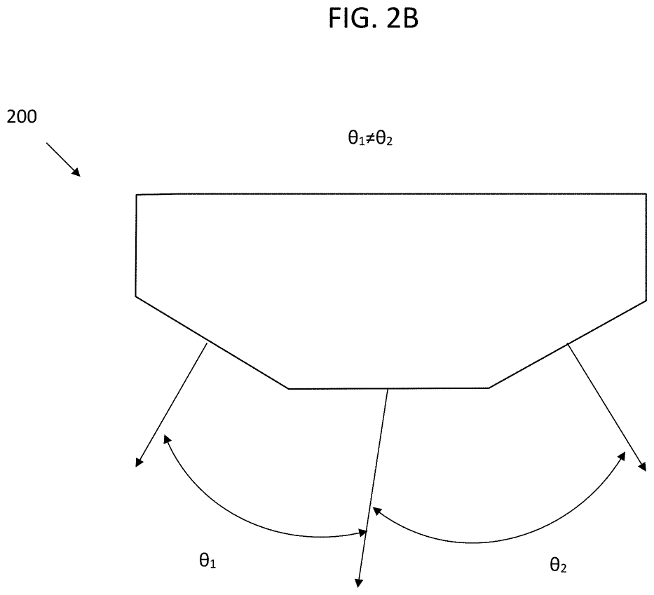

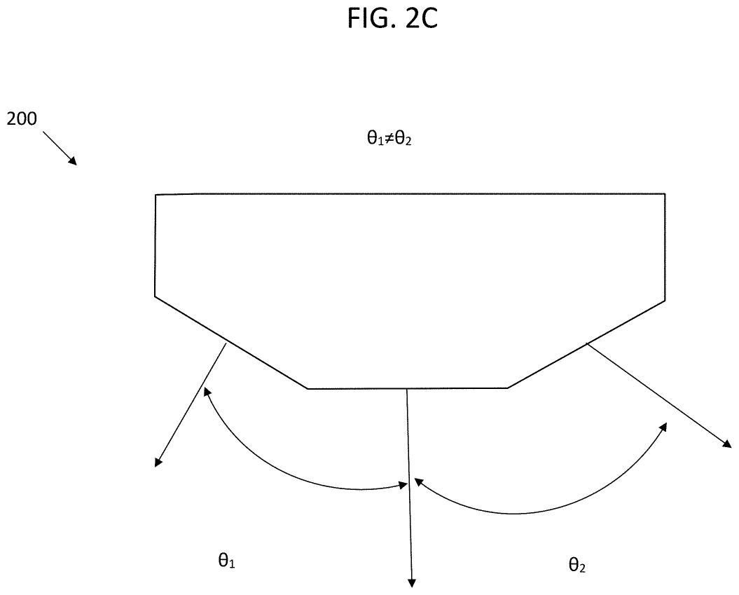

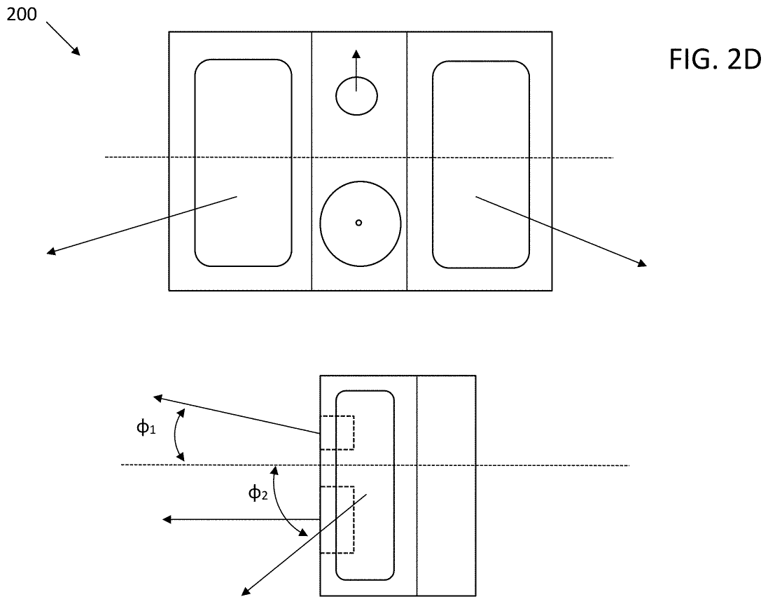

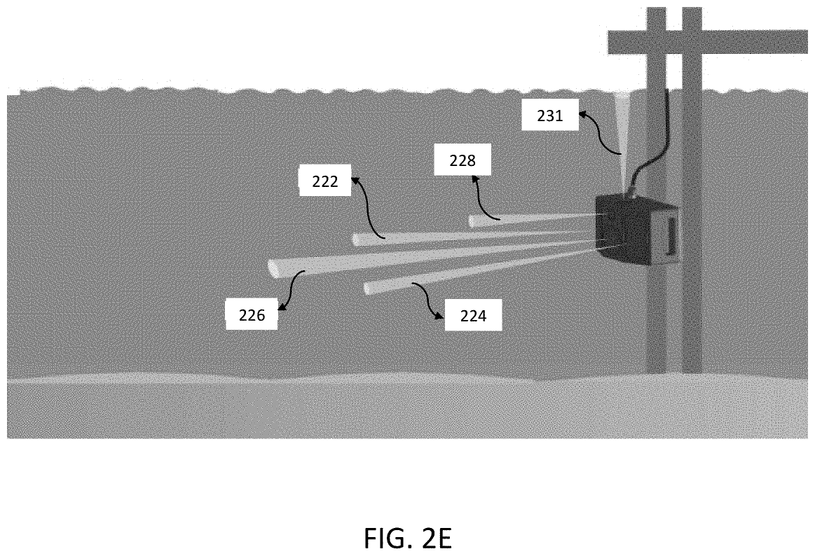

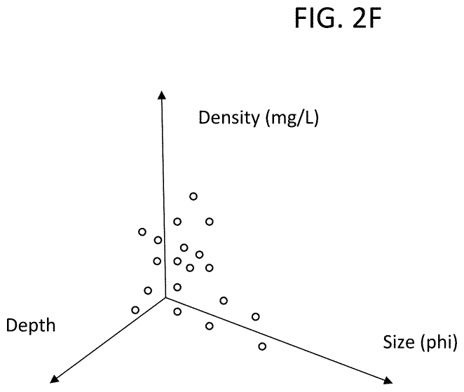

FIG. 2 illustrates an exemplary embodiment of a horizontal acoustic sediment current profiler (HASCP) apparatus 200 having multiple transducers. These multiple transducers may have various sizes and directions/orientations. Multiple beams and multiple frequencies are utilized by a single apparatus or platform to provide enhanced profiling capabilities. In one exemplary embodiment, two or more beams at different frequencies are used. For example, one beam may have an angular component in the flow direction for current profile measurement.

In the exemplary embodiment, the HASCP 200 may include three frequency configurations. As but one example, the three frequencies may be set to 600 kHz, 1200 kHz, and 2.4 MHz. That is to say, the HASCP apparatus may be configured to produce sound waves having the aforementioned frequencies, including simultaneously (in one approach, these three frequencies are produced from respective different transducers, although the present disclosure also contemplates implementations where two or more frequencies are generated from a common transducer, such as via time division multiplexing or superposition of waveforms).

It will also be recognized that each transducer may produce signals having various other frequencies in other embodiments (including those which are not multiples of one another), the foregoing values being merely exemplary. It will also be understood that a range or sub-band of frequencies may be used by each of the transducers, such as where the acoustic energy is distributed across a prescribed channel bandwidth (e.g., an X kHz-wide channel centered at Y kHz), and moreover any sidebands (due to e.g., modulation applied or other sources) may be used or alternatively rejected/filtered as needed.

In one configuration, first and second transducers 202, 204 may each be set to produce sound waves having a frequency of 1200 kHz. As shown in FIG. 2, the transducers 202, 204 are generally “front facing” and disposed so as to produce sound waves in the horizontal direction. Further, they may comprise multi-beam (e.g., dual-beam) transducers and be used concurrently, including for generation of multiple beams from each transducer.

The transducers are in one embodiment configured with a rectangular shape to provide a narrow beam width in one or more desired dimensions. The combination of the narrow beam width and relatively higher frequency (1200 kHz) of the exemplary embodiment allows precise measurements in the horizontal direction.

For example, the width of the beam produced by these transducers 202, 204 may be of a prescribed amount (e.g., 0.5 degrees), which may be selected so as to achieve a desired vertical beam dispersion or volume of ensonification. The geometry (beam width/dispersion, shape, and angle of each transducer face relative to one another) may also be selected to reduce boundary interference and provide longer, more precise (and higher accuracy) sediment measurements.

It is also contemplated that in some configurations, the beams may be steerable (whether mechanically and/or electronically) so as to optimize one or more desired characteristics, and to also enable generation of profile data as a function of different beam position.

Myriad other configurations and combinations of frequency and beam width may be utilized. Examples include, but are not limited to, a given acoustic beam being configured to be any width below 1 degree, or any width greater than 1 degree and below 3 degrees, or the surface of a given transducer being in other geometries (hexagonal, rectangular, square, triangular, etc.). In some variants, these transducers may be used independently of each other (e.g., only one active, or each operating for different applications). Advantageously, as noted above, the narrowness of the beam may be used to reduce boundary interference and provides longer, more precise, and higher-accuracy current and sediment measurements due to their spatial interrelationship and reduced interference. In some variants, the beam may be widened or narrowed depending on the application (as described in more detail below).

In some variants, the surface area of a transducer face which interfaces with the fluidic medium may also be modified as desired to achieve certain performance characteristics.

The third and fourth transducers 206, 208 are also present in the exemplary embodiment of the HASCP apparatus 200, and as shown are generally circular in transducer face profile. Recognizing that other frequencies may be utilized, the third transducer 206 is configured to produce beams utilizing a frequency on the order of 600 kHz in the exemplary embodiment. The fourth transducer 208 is configured to produce beams having a frequency on the order of 2.4 MHz (2400 kHz). The dispersion angle or beam widths of these transducers 206, 208 may be wider than those of the first and second transducers 202, 204 described above; for example, in one exemplary variant, the beam width of each of the third and fourth transducers is set to 1.5 degrees, although the beam width may be set to other configurations as discussed above, and even dynamically adjusted in some configurations order to obtain data from a range of different dispersion/width values for subsequent analysis.

As shown, the respective surface areas of the two frontal transducers 206, 208 may vary. In the exemplary variant, the third transducer 206 has a diameter of 4 inches, and the fourth transducer 208 has a diameter of 1 inch. These third and fourth transducers 206, 208 may be used for, among other things, precision measurement of acoustic echo sediment characteristics. Depending on desired orientation and placement of the device 200, the relative positions of the third and fourth transducers may be varied as well (e.g., larger diameter device on top).

As shown in FIG. 2A, the present disclosure also contemplates embodiments wherein the relative angles between (i) individual ones of the first and second transducer elements is varied (e.g., non-symmetric with respect to the housing 201 and/or each other); and (ii) the first and second, and the third/fourth transducer elements is varied (e.g., the third and fourth elements are skewed relative to the front face of the housing), whether in the horizontal plane as shown, and or in the vertical plane.

In the illustrated embodiment of FIG. 2, the third and fourth transducers 206, 208 face in generally a similar direction as the first and second transducers 202, 204 (albeit angled relative thereto), and the four beams generated thereby are also in this embodiment generally parallel to one another in the vertical dimension (albeit offset vertically). The variations in frequency associated with the acoustic beams generated by each of these multiple transducers (e.g., 600 kHz, 1200 kHz, 2400 kHz) may provide for precise measurements in varying conditions and distances from the exemplary HASCP apparatus 200.

Returning to the exemplary embodiment shown in FIG. 2, a fifth transducer 210 is configured to produce an additional vertical beam for, e.g., measuring the depth of the HASCP instrument 200 from the surface of the water. In the exemplary embodiment, the fifth transducer 210 may produce acoustic waves at 1200 kHz. The vertical orientation of the fifth transducer 210 enables the profiler apparatus 200 to, inter alia, measure a depth of the instrument underwater, or measure a distance to a solid surface above. In other variants, the fifth transducer 210 (or an additional transducer) may be disposed on a “bottom” side of the profiler apparatus 200, such that it may measure a distance to a floor of the body of water. The fifth transducer 210 and in fact any of the aforementioned transducers may be placed on any side of the apparatus 200 (e.g., back, sides, bottom, top, at an angle relative to surface of at least one side). The present disclosure also contemplates the use of multiple such transducers (e.g., on two or more different facets of the housing).

Thus, the exemplary apparatus may utilize both horizontal and vertical beams to, inter alia, measure multiple parameters such as depth and sediment/current velocity with increased precision. In some variants, the aforementioned five transducers may be used concurrently with one another (including simultaneously or in a time-divided manner), independently of one another, or in any combination depending on the use case.

In some variants, frequencies of e.g., the horizontal transducers 202-208 may be conditional on the depth measured by the vertical transducer 210, as discussed in more detail below.

Moreover, in one implementation, one of more of the transducers of the HASCP apparatus 200 may generate dynamically determined frequencies depending on the application or environmental factors. For example, the HASCP apparatus may be used for continuously determining current velocity and direction or sedimentation density as it is lowered into a body of water, measuring at different depths of the water. In other words, real-time operational data and status may be collected by the apparatus, and the unit may include logic to adaptively change one or more parameters such as frequency/frequency bandwidth, beam dispersion, azimuth/elevation, etc. based on the obtained data. For instance, situations where irregular shapes or obstructions are present in the water may call for different frequencies or other parameters to be used. While higher-frequency waveforms will generally yield more precise data, low-frequency waveforms travel farther in the water. Where distance is less of a concern, frequency may be raised to more precisely measure the water currents that are more immediately proximate to the apparatus. Moreover, other parameters such as “ping” interval may be adjusted based on range or distance considerations (e.g., allowing longer ping interval to enable reception of echoes emanating from more distance particles/objects within the fluid medium).

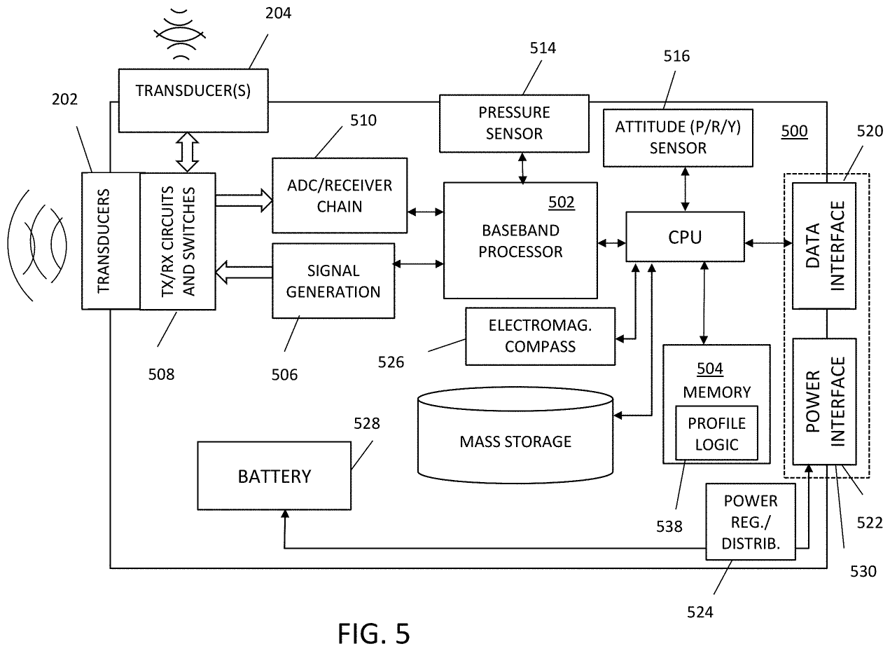

In some embodiments, ongoing determination of frequencies to be produced by the HASCP may be based on instructions embodied in a computer-executable medium in the apparatus (e.g., software or firmware configured to execute on the system processor(s)) as described in greater detail below with respect to FIG. 5. In some implementations, such determinations may be made at predetermined time intervals, based on environmental factors such as presence of obstructions, or water depth (measured by, e.g., measuring distance to the surface or bottom acoustically, or measuring water pressure using e.g., pressure detectors), or be event-driven (e.g., upon detection of one or more discrete events such as one or more parameters exceeding a prescribed threshold.

In contrast to prior art approaches such as those using a single transducer, the exemplary HASCP apparatus 200 further enables continuous profiling of water currents and collection of data using multiple transducers of varying frequency, geometry and functionality incorporated into a single system to enable precise current/sediment profiling form a common location. Hence, rather than setting up multiple discrete transducers and supporting systems at discrete locations as in FIG. 1B (including selection of appropriate frequency of operation for each), the apparatus and methods enable highly unified installation, data collection, and data processing/storage, thereby greatly simplifying the sediment/current profiling operation relative to the prior art.

In another embodiment, the apparatus may have modular transducers. A modular component may be interchangeable with another modular component, where each modular component has different configurations of transducers, e.g., different numbers, shapes, angles, surface areas of transducers. For instance, the housing 201 may be constructed of three separable sub-housings or components which can be combined with other modules in order to enable user- or application-specific of each unit.

In another embodiment, one or more of the facial modules of the housing (e.g., the center module of the front face of the apparatus having the circular transducer elements 208, 206) is reversible, such that the orientation of the transducer elements can be flipped 180-degrees if desired. It will also be appreciated that different functional modules may be substituted within the apparatus 200, such those with different transducer types/operating frequency ranges, different beam dispersion characteristics, different elevation/azimuth orientations, etc. depending on the intended application.

In other embodiments, the HASCP apparatus may have mounting brackets, hooks, clamps, and/or recesses 212, or other means of attaching to underwater surfaces as are known in the art. At least one cable interface 214 may be used for a range of functions including mechanical support (e.g., lowering the apparatus below water's surface), electrical power, and/or data interface. For example, in some embodiments, the apparatus may be powered through the cable interface by an external power source rather than, or in addition to, an onboard battery (the latter which may be used for instance in the event of loss of external power, or where use of an external cable is not feasible). Constant rapid pings and acoustic wave generation may require a stable source of energy, and hence, a stable source of power is advantageous for extended periods of measurements.

It will be recognized that other frequencies, transducer configurations, angles and sizes, and beam widths may be used with equal or greater effect depending on their application. For example, waters with certain particulate density or size ranges may require greater sensitivity to detect particles in the water. In that case, a different set of parameters such as higher frequency and narrower beam width may be used.

Those having ordinary skill in the relevant arts, given the present disclosure, will also recognize that additional (or fewer) transducers, frequencies, angles, sizes and widths of beams may be used to increase precision of current and sediment measurements, as well as introduce greater functionality as needed on the HASCP apparatus.

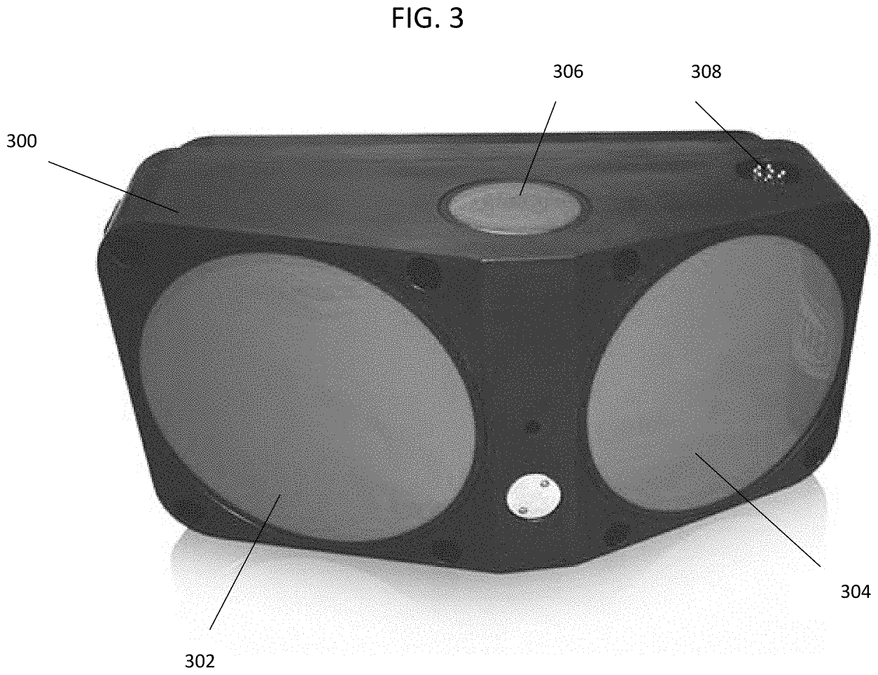

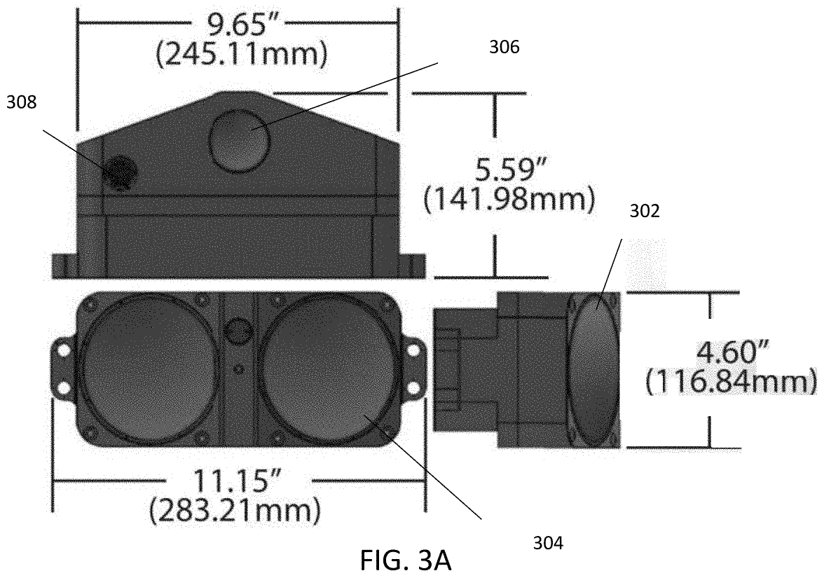

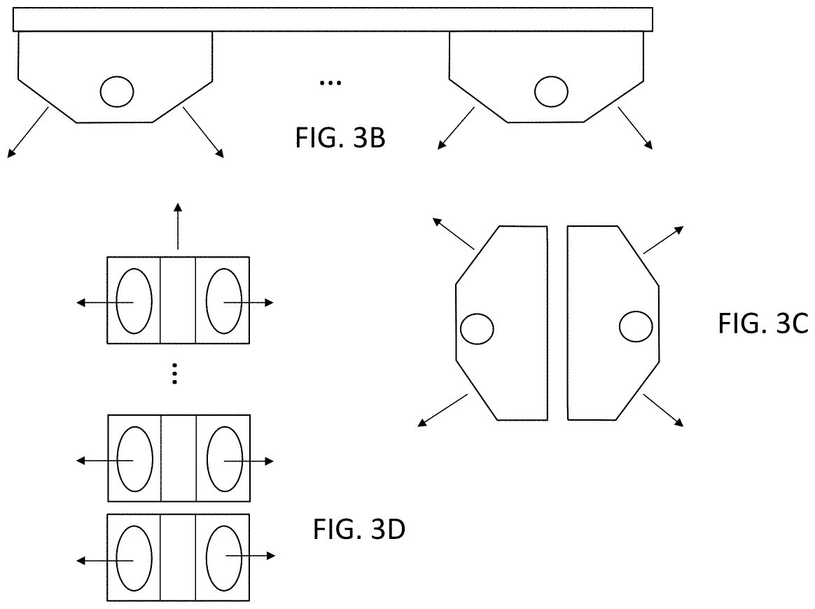

Purely by way of illustration, FIGS. 2A-2C are top elevation views of various exemplary alternate combinations of beam directions formed by the various transducer elements of the apparatus of FIG. 2, including symmetric and asymmetric azimuth configurations. As shown, the present disclosure contemplates that (i) the “horizontal” beams generated by the rectangular transducers (or those of the apparatus 300 of FIG. 3, discussed below) may be symmetric or asymmetric in azimuth with respect to each other and/or the apparatus housing 201, whether by electronic steering or disposition of the beams or via mechanical placement or steering of the transducer elements, and/or (ii) the “horizontal” beams generated by the rectangular transducers (or those of the apparatus 300 of FIG. 3, discussed below) may be symmetric or asymmetric in azimuth with respect to the beam(s) formed by one or more of the central transducer elements 206, 208, whether by electronic steering or disposition of the beams or via mechanical placement or steering of the various transducer elements. As such, each of the beams can be pointed, whether electronically or mechanically, in a desired direction (i.e., azimuth, and elevation relative to a horizontal plane) so as to achieve a desired result, including e.g., reduced spatial overlap or dispersion of beams out to at least a certain range, enhanced spatial coverage, overlap of beams (i.e., where desired to have two or more beams cover a common spatial coordinate), or for other purposes which will be recognized by those of ordinary skill given the present disclosure.

Similarly, FIG. 2D shows an exemplary alternate combinations of beam directions formed by the various transducer elements, including symmetric and asymmetric elevation configurations.

FIG. 2E is an illustration of one exemplary usage scenario for the HASCP apparatus of FIG. 2 shown exemplary acoustic beams formed thereby, in accordance with the principles of the present disclosure. Specifically, FIG. 2E shows positioning and directions of first and second beams 222, 224 corresponding to the first and second transducers 202, 204, as well as third and fourth beams 226, 228 corresponding to the third and fourth transducers 206, 208 of the apparatus 200. The first through fourth beams 222-228 face substantially the same direction (i.e., in a generally horizontal direction, albeit at different azimuth for some of the beams and potentially with different elevation angles relative to a horizontal plane as previously described with respect to FIGS. 2A-2D), while a fifth beam 230 corresponding to the fifth transducer 210 propagates in a generally orthogonal (e.g., vertical) direction. As illustrated, the apparatus 200 may be mounted onto a stationary object such as a pillar. However, as noted elsewhere herein, the apparatus may be mounted on moving vehicles or objects (e.g., ship hull) anchored to the bottom of a body of water, suspended by a cable, or used in yet other configurations such as in a hydrodynamic form factor (e.g., “torpedo” shape) within a towed array configuration (e.g., a stable subsurface platform which maintains an effectively constant depth while towed by a research vessel or other platform).

FIG. 2F is a three-dimensional plot of an exemplary sediment particulate distribution obtained using the acoustic profiling apparatus of the present disclosure. In this example, particle size and density are mapped as a function of depth of the body of water, although it will be appreciated that numerous other data analysis and presentation formats may be used for data obtained from the apparatus. For example, a 3D (“contour map”, or spatial distribution such as one in Cartesian, polar, or spherical coordinates) plot of a given portion of the body of water illustrating particulate size or density variations may be generated, as may a current profile as a function of depth and/or other parameters of the body of water (e.g., transverse channel position). As such, the apparatus and methods described herein are useful for many types of e.g., real-time characterization of flowing bodies of water such as rivers or ports/harbors.

It will also be appreciated that the data generated by the apparatus 200 may be processed and stored locally, stored locally prior to significant processing (e.g., before determination of echo frequency distributions, Doppler shifts, etc.) for later download or retrieval, or streamed off-device via e.g., the cable if used or other data interface to an external device for further processing.

FIG. 3 is a front perspective view of another embodiment of the HASCP apparatus of the present disclosure. In this embodiment, two lower-frequency (e.g., 600 kHz) “horizontal” transducers 302, 304 are utilized, with a vertical higher-frequency transducer 306 used for e.g., vertical (surface) height determinations. In this embodiment the apparatus includes two first transducers 302, 304 disposed on respective front faces of the housing 301 and configured to generate acoustic beams at prescribed frequencies (e.g., 600 kHz) and angles relative to one another (and with prescribed dispersion, such as 1.5 degrees), and a third transducer 306 mounted on a top surface of the housing 301 configured to emit a substantially vertical beam at a different frequency (e.g., 1200 kHz). A data and/or electrical interface 308 penetration and coupling is also located on the top surface of the housing 301 to permit mating of power and/or electrical cabling to the apparatus 300.

FIG. 3A is a composite front, top and side elevation view of the HASCP apparatus of FIG. 3, showing exemplary dimensions and features thereof.

The apparatus 300 of FIGS. 3-3A includes a variety of features and functions, including: (i) ability to measure horizontal current profiles; (ii) surface height measurement capability; (iii) variable water profile range (e.g., from 8 cm to 90 m from the device 300); (iv) a pressure sensor, as well as pitch/roll sensors and an electronic compass; (v) real-time data processing or recordation of data to internal (e.g., 32 GB SD memory card) and post processing with software; (vi) output the industry standard and proprietary formats including RTB, RTD, PD0, PD3, PD4, PD5, PD6, PD13 (RTB binary data format includes Beam, Instrument, Earth velocities, Echo Intensity, Correlation and NMEA); (vii) GPS receiver connection directly to the HASCP such that the NMEA data is utilized and recorded with the ensemble data; (viii) export capability to PD0, MATLAB, CSV and Python.

Moreover, the exemplary apparatus 300 of FIG. 3 is configured to support up to 12 different configurations in a single deployment (e.g., frequencies, dispersions, etc.), and includes both field-replaceable transducers (e.g., if any damage occurs to the device), and a modular electronics package.

In one variant of the apparatus, multiple (e.g., 8) channels of electronics are provided, so as to support the formation of up to 8 distinct acoustic beams via the transducer elements. Moreover, using the data interface (FIG. 5), the apparatus can be integrated into e.g., AIS and other harbor systems (such as via use of a standard serial port or Ethernet interface).

In one embodiment, the housing 301 of the apparatus is fabricated from Acetal. In another embodiment, the housing is fabricated from an alloy, such as one that is aluminum- or titanium-based. Other materials such as fluoropolymers (e.g., ETFE) may be used in certain applications as well.

FIGS. 3B-3D illustrate various embodiments of multi-HASCP array apparatus according to the present disclosure. It will be recognized that while shown with respect to the embodiment of the apparatus 300 of FIG. 3, the configurations of FIGS. 3B-3D may be used with the apparatus 200 of FIG. 2, or yet other configurations as contemplated herein.

As shown in FIGS. 3B-3D, two or more HASCP apparatus 200, 300 may be used in a coordinated or array fashion, including (i) in one or more linear arrays (FIG. 3B) wherein individual devices are juxtaposed; (ii) in “back to back” configuration (FIG. 3C), including also e.g., tri-element, quad-element, or additional similar back-to-back configurations, or (iii) in a vertical stacked arrangement (FIG. 3D). The present disclosure further contemplates coordination (whether real-time, or post-processing) between the different individual HASCP apparatus of each array, such as via common data connections to an external processing entity such as a controller, and/or interconnection of power and/or data between individual apparatus. Moreover, it is contemplated that the individual HASCP apparatus may be heterogeneous as well as homogeneous in configuration; e.g., one apparatus 200, 300 may be configured to operate at different frequencies, modulation types, beam dispersions, ping intervals, etc. that one or more other apparatus in the array. Moreover, the physical configurations of the individual apparatus may be heterogeneous, such as where the external dimensions vary, the types of signal processing or transducer configurations vary, etc.

Additionally, in one variant of the configuration of FIG. 3B, the “linear” array can be curved or bent such as into an arc with a prescribed function/shape or curvature, e.g., with the individual array units 200, 300 disposed on the outer edge of the curved arc shape (not shown). Similarly, a “stair-step” configuration may be used (not shown), such as where each array element 200, 300 has a different elevation than others in the array but is translated laterally from its neighbor.

Each constituent HASCP apparatus generates high resolution, high accuracy horizontal current profiles, and hence when used in array fashion, is further capable of monitoring currents near the surface as well as at several locations/depths using the multiple linked devices.

### Methods—

Exemplary methodologies for enhanced acoustic sediment and current profiling are described below based on exemplary apparatus such as that the horizontal acoustic sediment and current profiler (HASCP) apparatus illustrated in FIGS. 2 and 3. While described in the context of the foregoing apparatus, other types of acoustic profilers may be used given the contents of the present disclosure, e.g., where number of transducers, angles, beam widths, etc. may be modified for different applications. Moreover, software on-board the profiler apparatus may be embodied on computer-readable apparatus, which may contain a computer program with instructions executable by a processor apparatus or operable by logic, enabling a profiler apparatus to perform the operations described below.

As used herein, the term “computer program” or “software” is meant to include any sequence or human or machine cognizable steps which perform a function. Such program may be rendered in virtually any programming language or environment including, for example, C/C++, Fortran, COBOL, PASCAL, Ruby, Python, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like, and run on any number of different operating systems (OS) such as Android, Linux, iOS, etc.

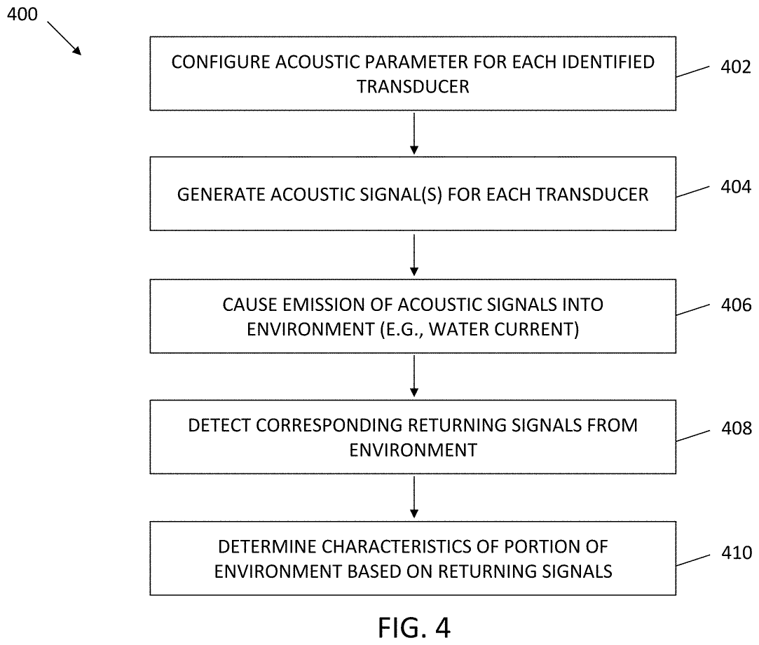

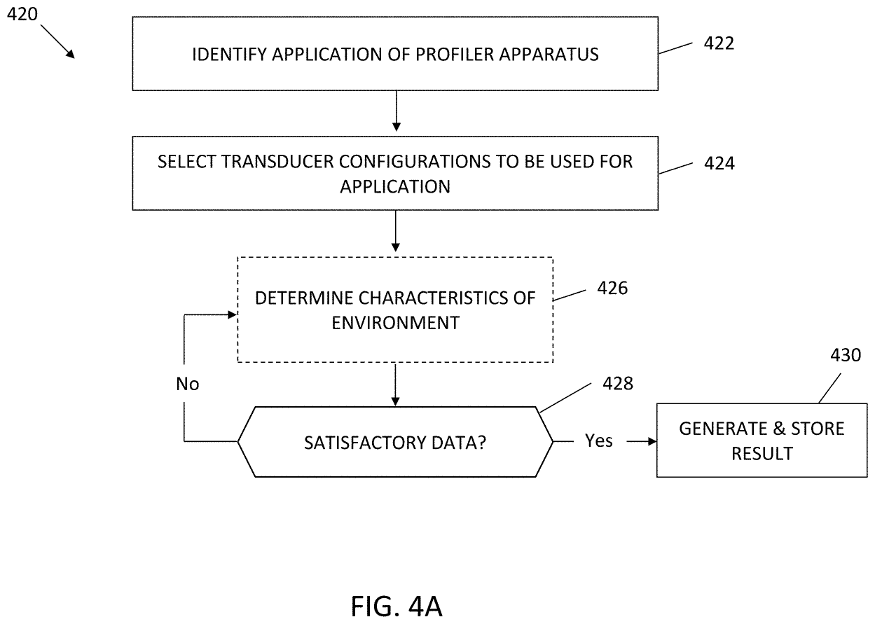

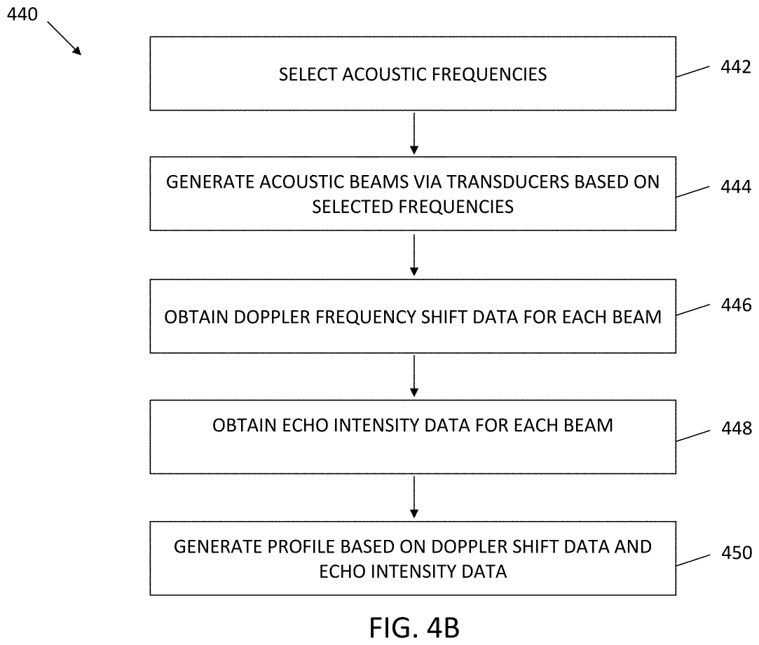

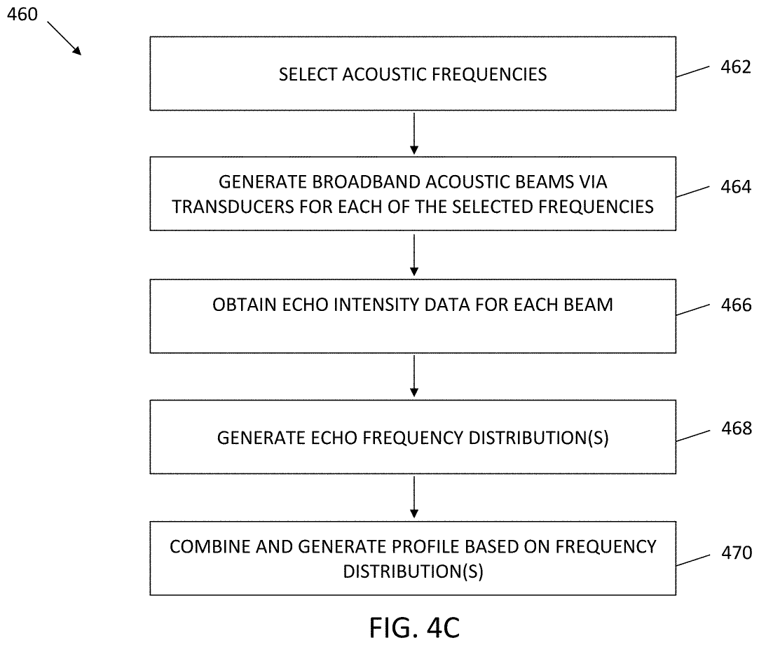

FIG. 4 is a flowchart illustrating an exemplary embodiment of a generalized method 400 for profiling a water current. It will be appreciated that while various aspects of the method 400 are described with reference to the exemplary apparatus 200, 300 of FIGS. 2 and 3 described above, it may be practiced by other apparatus, the referenced configurations being merely exemplary.

At step 402 of FIG. 4, a profiler apparatus (e.g., the HASCP apparatus 200, 300) identifies one or more transducers of the profiler apparatus to be used (e.g., based on user input or a prior configuration data file or other), and configures at least one parameter of an acoustic beam to be emitted by each identified transducer. In one embodiment, the emitted frequencies are determined by a baseband processor apparatus and/or a signal generator (see, e.g., FIG. 5) that are operable on the profiler apparatus 200, 300. Frequencies may be determined based on predetermined settings (e.g., stock settings or user-configured settings, such as those set forth in Appendix I hereto). In one example, a plurality of transducers may be configured to emit 600 kHz, 1200 kHz, or 2400 kHz as discussed above (frequency=f₀).

In another embodiment, the frequencies may be determined on a dynamic basis. That is, one or more of the frequencies may change during operation of the apparatus. In one variant, as sedimentation density or current velocity increases (determined based on, e.g., other steps described below), the frequency may be varied so as to improve precision of data or achive other performance objectives. In another variant, as the apparatus is lowered beneath a prescribed depth level or above a prescribed water pressure, or rotated in a given azimuth or direction, the frequency may be e.g., lowered to allow acoustic pings to travel farther in the water. In other embodiments, the acoustic parameter may be a beam width (e.g., 0.5-1.5 degrees) or an amplitude of the emitted signals, each of which may be predetermined or modified during operation, as may ping interval.

At step 404 of the method 400, the profiler apparatus generates one or more acoustic signals for each transducer to be operated. The acoustic signals in one exemplary embodiment are sound waves generated by a signal generator of the profiler apparatus (see, e.g., FIG. 5). The signals may be discharged from a given transducer in one of various forms of sound waves (e.g., analog waves, pulses) that are focused in a beam in substantially the same direction normal to the face of the transducer, or otherwise electronically steered relative thereto (such as where multi-element transducers are utilized). The signals may have a set duration or length (e.g., short pulses, multiple wavelengths) as well as frequency spectrum (e.g., they may be narrowband in nature, or broadband).

At step 406, the profiler apparatus causes emission of the generated acoustic signals into the environment from the identified transducers. In typical use cases, the profiler apparatus is submerged underwater for detection and measurement of current velocity, sedimentation profile, etc. In one embodiment, the emission of sound waves from the transducers may be driven by the signal generator of the profiler apparatus (and other components such as transmit/receive switches in the transmit chain of the device). In some variants, the signals may be emitted in bursts (e.g., pulses), or alternatively longer or even continuous waves.

At step 408, the profiler apparatus detects corresponding returning acoustic signals (e.g., echoes) from the environment. In one embodiment, a receiver chain of the profiler apparatus is configured to detect sound waves that have echoed back from interacting with particles such as sediment in the water. As an aside, bodies of water contain particulates, microorganisms (e.g., zooplankton), and sediments that flow with the water; sound waves may interact with these particles and return sound waves that have a different frequency because of the movement of the particles and the aforementioned Doppler effect. Moreover, these returning waves may be of varying intensity or amplitude, depending on various factors relating to their reflection and propagation back to the transducer(s).

More specific configurations may involve registering sound waves that have a similar profile as the signals generated and emitted. For example, if a 1200 kHz sound wave was emitted within a specified (or dynamically determined) time period (e.g., in the last 300 milliseconds) or gating window, and the receiver has detected one or more acoustic signals that have a frequency within a prescribed range or relationship of the transmitted waveforms and f the receiver may infer that the signal is a corresponding returning signal from the emitted signal. As such, threshold ranges of time and frequency may enable the profiler apparatus to determine which signals to use in calculating, inter alia, Doppler frequency shifts as well as echo intensity and frequency distribution profiles.

In one embodiment, data collected using the above means may be stored in a storage device on the profiling apparatus. In another embodiment, the data may be transferred to an external storage apparatus, via, e.g., cable interface 214 or another data interface (e.g., physical data cable such as the data interface 512 shown in FIG. 5). While the data interface may be wired cabling in some variants, in other variants, the data interface may include a wireless interface as is known in the relevant art. As used herein, the term “wireless” means any wireless signal, data, communication, or other interface including without limitation Wi-Fi, Bluetooth/BLE, 3G (3GPP/3GPP2), HSDPA/HSUPA, TDMA, CBRS (Citizens Broadband Radio Service), CDMA (e.g., IS-95A, WCDMA, etc.), FHSS (frequency-hopping spread spectrum), DSSS (direct-sequence spread spectrum), GSM, PAN/802.15, WiMAX (802.16), 802.20, Zigbee®, Z-wave, narrowband/FDMA, OFDM, PCS/DCS, LTE/LTE-A/LTE-U/LTE-LAA, 5G NR, LoRa, IoT-NB, SigFox, analog cellular, CDPD (Cellular Digital Packet Data), satellite systems, millimeter wave or microwave systems, acoustic, and infrared (i.e., IrDA). For example, in one configuration, the apparatus 200, 300 may include (either directly, or indirectly via the interface cable 214) a signal path to one or more antenna elements which may rise near or above the surface of the water and enable wireless RF communications with a receiver.

At step 410, the profiler apparatus determines characteristics of at least a portion of the environment based on the returning acoustic signals detected in step 408. In one exemplary embodiment, water current velocity (in up to three dimensions) may be determined based on the detected signals. More specifically, the difference between f₀ and f obtained above indicates a shift in frequency that is in turn indicative of the velocity of the source of the emission (i.e., the water current). Equation 1 is a basic formula that describes the relationship among observed frequency, emitted frequency, and velocity of source in one dimension:

f=f₀*((c+Vₒ)/(c+Vₛ)) Eqn. 1
f=observed frequency
f₀=emitted frequency
c=speed of sound=340.29 m/s
Vₒ=velocity of observer (0 if the profiling apparatus is stationary)
Vₛ=velocity of source (negative if current is moving toward profiling apparatus)

Thus, the velocity of the water current (Vₒ) may be determined based on frequencies observed from signals that return from interaction with particles in the water. The accuracy of the current velocity is enhanced by virtue of signals having specific frequencies and beam widths, and physical configurations (e.g., diameters of transducers) as discussed with respect to the exemplary embodiments of FIGS. 2 and 3.

As is known, multiple transducers may also be used for measurement of, e.g., a vector associated with the water current in multiple dimensions (e.g., directions in three-dimensional space). In addition, a transducer in another direction (e.g., fifth transducer 210 pointed in the vertical direction) allows the same profiling apparatus (e.g., HADCP apparatus 200) to simultaneously measure other characteristics of the environment, such as depth from the surface of the water.

FIG. 4A is a flowchart illustrating an exemplary embodiment of another method 420 for profiling a water current.

At step 422, a profiler apparatus identifies at least one application for usage. In one exemplary embodiment, the profiler apparatus is the HASCP apparatus 200 described with respect to FIGS. 2 and 3, which may use perform sonar profiling methods to obtain various measurements. Examples of an application include (but are not limited to) determination of water current velocity, flow direction and acceleration, discharge (volume), flow velocity index, sedimentation density, particle size distribution, lifeform distribution (e.g., fish, microorganisms), wave height and direction, turbulence, bottom tracking (distance to bottom of body of water), and distance to the surface.

As noted elsewhere herein, multiple frequencies and beam widths utilized in a single acoustic system may enable enhanced accuracy and precision of measurements, as well as enable real-time characterization of the water based on measurements from a single observation point. The enhanced profiling system of the present disclosure may be useful for, inter alia, studying water profile (e.g., pollution, flow rate) for hydrographic surveys, and navigation. Prior systems typically operate at a single fixed acoustic frequency for all beams in the range of 300-4000 kHz, and were “non-unified” apparatus such as the various embodiments described herein. Such unification allows for, inter alia, common control and support functions such as electrical power, attitude sensing, surface height determination, physical/spatial compactness, frequency planning/re-use, and real-time data processing.

At step 424, the profiler apparatus initiates one or more transducers to be used for the determined application(s). Depending on the usage, some or all of the onboard transducers may be required.

In one embodiment, referring back to FIG. 2, all five transducers may be initialized such that the HASCP apparatus 200 may utilized horizontal profiling (e.g., with the first through fourth transducers) and vertical profiling (e.g., with the fifth transducer). In embodiments where more than five transducers are present (e.g., on other faces of the HASCP apparatus), additional measurements may be taken. For example, the “front facing” transducers and receivers may determine current velocity, and the “top” transducer may measure distance to surface, while transducers and receivers present on one or more the “sides” may be configured to measure, e.g., particle size distribution. As such, the HASCP apparatus may take multiple readings from one location simultaneously. In some variants, however, only some of the different applications may be active at once, effectively taking turns so as to, e.g., minimize interference from acoustic waves emitted from other transducers.

At step 426, the profiler apparatus determines characteristics associated with the environment. In one exemplary embodiment, the profiler apparatus implements steps 402-410 as described in FIG. 4.

At step 428, the profiler apparatus determines whether sufficient or satisfactory data has been collected. In one embodiment, the profiler apparatus obtains more than one measurement to increase the confidence of the accuracy of the collected data (e.g., observed frequencies). In one variant, the profiler apparatus collect data for a set number of pings or time period (e.g., 10 measurements or 180 seconds). In another variant, the profiler apparatus continues to collect data until the deviation, or error, is within a threshold (e.g., standard deviation associated with a given number of measurements stays below a given threshold). In another variant where the profiler apparatus is in motion (e.g., lowered by cable, on a moving platform, etc.), the measurements and data collection must be determined to be satisfactory at every given distance interval. For instance, a confidence metric associated with obtained data must meet one or more criteria (as discussed above) at every depth level of e.g., 10 meters.

If the profiler apparatus determines that the collected data is satisfactory, the profiler apparatus proceeds to step 430, where the apparatus generates and/or stores the result for the application identified at step 422. In some embodiments, results may be rendered in readily observable format such as a graph, table, map, or figure. For example, if measuring a current velocity, the result may include the velocity, direction, and a map of vectors. As another example, measurements of particle distribution may be shown in a heat map or distribution graph. In various implementations, the results may be stored on a local or remote storage device (transmitted by, e.g., cable interface or another data interface as discussed above).

FIG. 4B is a logical flowchart illustrating another exemplary embodiment of operating a current profiler apparatus according to the present disclosure.

As shown, the method 440 includes first identifying or selecting the target acoustic frequencies (or bands) per step 422. For instance, in one application, a narrowband 600 kHz signal may be used. Alternatively, in other applications a broadband signal centered at e.g., 100 kHz may be used.

Next, per step 424, the acoustic beams are generated at the selected frequency/frequencies via the transducers.

Per step 446, the Doppler shift data for each beam is obtained (e.g., based on returning echoes or signals reflected from sediment particles).

Per step 448, echo intensity data for each beam is obtained (e.g., based on returning echoes or signals reflected from sediment particles).

Lastly, per step 450, one or more current or sediment profiles are obtained based on the obtained Doppler frequency shift data and the echo intensity data for the various beans (and associated frequencies).

FIG. 4C is a logical flowchart illustrating yet another exemplary embodiment of a method of operating a current profiler apparatus according to the present disclosure.

As shown, the method 460 of FIG. 4C includes first selecting one or more acoustic frequencies for each transducer (as described previously) per step 462. In one variant, the selected frequencies are center frequencies for broadband waveforms of the type previously described.

Next, per step 464, the broadband acoustic beams are generated and transmitted via the respective transducer(s).

At step 466, echo data is obtained relating to each of the transmitted beams, and respective echo frequency distributions are calculated per step 468. Note that these distributions will often differ appreciably based on the use of different frequency of acoustic energy, etc.

Lastly, at step 470, the individual echo frequency distributions are combined and one or more profiles generated based thereon.

### Apparatus—

FIG. 5 is a functional block diagram of circuitry and other components of an exemplary profiling apparatus such as the horizontal acoustic sediment and current profiler (HAS/CP) apparatus 200, 300 described with respect to FIGS. 2-4 herein. It will be appreciated that the various components and configurations of the apparatus 500 of FIG. 5 may be substituted with those described in, inter alia, co-owned U.S. patent application Ser. No. 16/292,069 filed Mar. 4, 2019 and entitled “HYBRID TRANSDUCER APPARATUS AND METHODS OF MANUFACTURE AND USE”; Ser. No. 16/131,970 filed Sep. 14, 2018 entitled “MULTI-FREQUENCY PISTON TRANSDUCER”, Ser. No. 13/773,447 filed Feb. 21, 2013 and entitled “ACQUATIC VELOCITY SCANNING APPARATUS AND METHODS”, Ser. No. 14/460,853 filed Aug. 15, 2014 and entitled “SUB-ARRAY TRANSDUCER APPARATUS AND METHODS”, and Ser. No. 13/282,257 filed Oct. 26, 2011 end entitled “MULTI FREQUENCY 2D PHASED ARRAY TRANSDUCER”, each of the foregoing incorporated herein by reference in its entirety, depending on desired functionality and application. For example, as will be appreciated by those of ordinary skill in the art given the present disclosure, in some applications, the piston-type transducers referenced above can be used as one or both of the first/second/third (as applicable) transducers of the apparatus 200 of FIGS. 2-3D. Similarly, the transmit/receive and processing chains and logic in the above-referenced patent applications can be used as the basis of or combined with the various aspects and algorithms described herein to produce an apparatus with the desired functionality (e.g., horizontal current/sediment profiling).

Referring to FIG. 5, the exemplary profiling apparatus 500 includes, inter alia, a baseband processor apparatus 502, a memory subsystem 504, signal generator apparatus 506, transmit/receive switches and logic 508. Transducer apparatus (e.g., the first and second sets of transducers 202, 204 of the embodiment of FIG. 2), an ADC and receiver chain 510, as well as mass storage device, CPU, pressure sensor 514, attitude sensor 516 (e.g., to sense pitch/roll/yaw of the device 500), electromagnetic compass 526, data interface 520, electrical power interface 522 and supporting power regulation/distribution circuitry 524, and an (optional) battery 528. The device 500 also includes computer logic (e.g., software or firmware 538) operative to execute on the CPU or baseband processor to implement the various functions and methodologies described previously herein.

In the exemplary embodiment, the baseband processor apparatus 502 and CPU may each include one or more of a digital signal processor (DSP), microprocessor, field-programmable gate array, GPU, FPGA, or plurality of processing components mounted on one or more substrates. The processor apparatus may also comprise an internal cache memory, and be in data communication with the memory subsystem 504, which can comprise, e.g., SRAM, flash and/or SDRAM components. The memory subsystem may implement one or more of DMA type hardware, so as to facilitate data accesses as is well known in the art. The memory subsystem of the exemplary embodiment contains computer-executable instructions (embodied in, e.g., a computer program) which are executable by the processor apparatus.

In the exemplary embodiment, the signal generator logic 506 is an audio-frequency signal generator in data communication with the baseband processor apparatus 502. The signal generator may be configured to synthesize audio waves as a function, or may generate arbitrary source waveforms. The processor apparatus may specify to the signal generator the frequency of the audio signals to be used by one or more transducers (e.g., 600 kHz, 1200 kHz, 2400 kHz). As alluded to above, the frequency provided to the signal generator (and generated by the signal generator) may change during operation of the transducers. The signal generator logic 506 may in many embodiments include or be in data communication with logic operable thereon and/or computer-readable memory apparatus having a computer program thereon, each of which may cause generation of audio signals and storage of signals received.

Additionally, the exemplary embodiment of the HASCP apparatus 500 includes a linear receiver (not shown) for echo intensity measurements. In one specific variant, the receiver may operate at an echo backscatter dynamic range of 100 dB with a resolution of 0.2 dB, although other configurations may be used consistent with the present disclosure.

The exemplary profiling apparatus 500 also includes a cable interface 530, which in one embodiment includes the data and electrical power interfaces 520, 522. In addition, in some embodiments, the profiling apparatus 500 may include a data interface for data transmission to another device. Other devices may include a user interface, an external storage device, a computing or processing device, or another profiling apparatus. In the case of transmitting data to another profiling apparatus, this sharing of data may allow a greater range of profiling. Rather than limiting profiling and measurements to a certain field of view or distance, linking multiple profiling apparatus may result in a wider map (e.g., of current velocities) or more extensive collection of data. As noted above, data transmission may be accomplished by wired or wireless means. In addition, the data interface may enable user operation and setup via the user interface. The user may, for example, set or modify the emitted frequencies from above water before or during operation, as opposed to presetting the parameters each time it is installed underwater to collect data (although the exemplary profiling apparatus may dynamically update the parameters of the acoustic signals on its own, as discussed above).

Where certain elements of these implementations can be partially or fully implemented using known components, only those portions of such known components that are necessary for an understanding of the present disclosure are described, and detailed descriptions of other portions of such known components are omitted so as not to obscure the disclosure.

The processes described herein may be performed by an acoustic processing system including at least one processor and a non-transitory computer-readable storage apparatus having a storage medium. The storage medium stores a number of computer-executable instructions thereon, that when executed by the at least one processor, cause the at least one processor to perform the processes described herein. In an embodiment, the acoustic processing system may be partially or wholly implemented in the HASCP apparatus 200, 300 or may be implemented partially or wholly in an external device (e.g., in a computing device or mobile device in data communication with the HASCP 200, 300, that is separate from the HASCP system that obtained the acoustic data). The various methodologies described herein are useful in, for example, analysis, processing, storage and/or transmission of this captured acoustic data.

Additionally, the processes and methodologies described herein (or portions thereof) may be performed by dedicated computerized system logic, including without limitation, application-specific integrated circuits (ASICs), field-programmable gate arrays (FPGAs), GPUs, DSP, and/or other types of integrated circuits or dedicated computerized logic that may be utilized in addition to, or alternatively from, the aforementioned computer-readable storage apparatus.

Moreover, in the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), GPUs, DSPs, systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, (G)DDR/2/3/4/5/6 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), GPUs, array processors, secure microprocessors, application-specific integrated circuits (ASICs), and/or other digital processing devices. Such digital processors may be contained on a single unitary IC die, or distributed across multiple components.

It will be recognized that while certain aspects of the technology are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

APPENDIX I
EXEMPLARY PROFILER EMBODIMENTS AND SPECIFICATIONS
© Copyright 2018-2019 Rowe Technologies, Inc.

| | | | | |
|---|---|---|---|---|
| 300 kHz | 600 kHz | 600 kHz | 600 kHz | 1200 kHz |
| 3″ Beams | 3″ Beams | 2″ Beams | 1″ Beams | 2″ Beams |

Water Profile:

| Broadband | 100 m | | 50 m | | 45 m | | 40 m | | 20 m | |
|---|---|---|---|---|---|---|---|---|---|---|
| | @ 4 m Bin | | @ 2 m Bin | | @ 2 m Bin | | @ 2 m Bin | | @ 1 m Bin | |
| | Size | | Size | | Size | | Size | | Size | |
| Narrowband | 150 m | | 75 m | | 70 m | | 50 m | | 30 m | |
| | @ 4 m Bin | | @ 2 m Bin | | @ 2 m Bin | | @ 2 m Bin | | @ 1 m Bin | |
| | Size | | Size | | Size | | Size | | Size | |
| Minimum Blanking | 32.0 | cm | 16.0 | cm | 16.0 | cm | 16.0 | cm | 8.0 | cm |
| Distance | | | | | | | | | | |
| Minimum Bin Size | 2.8 | cm | 1.4 | cm | 1.4 | cm | 1.4 | cm | 0.7 | cm |
| Maximum Number | 200 | bins | 200 | bins | 200 | bins | 200 | bins | 200 | bins |
| of Bins | | | | | | | | | | |
| Velocity Resolution | 0.01 | cm/s | 0.01 | cm/s | 0.01 | cm/s | 0.01 | cm/s | 0.01 | cm/s |
| Long-Term | ±0.25% | | ±0.25% | | ±0.25% | | ±0.50% | | ±0.25% | |
| Accuracy | ±2 mm/s | | ±2 mm/s | | ±2 mm/s | | ±1.5 mm/s | | ±2 mm/s | |
| BB Single Ping | 3.5 cm/s | | 3.5 cm/s | | 3.5 cm/s | | 3.5 cm/s | | 3.5 cm/s | |
| Precision | @ 4 m bin | | @ 2 m bin | | @ 2 m bin | | @ 2 m bin | | @ 1 m bin | |
| | size | | size | | size | | size | | size | |
| NB Single Ping | 20.0 cm/s | | 20.0 cm/s | | 20.0 cm/s | | 20.0 cm/s | | 20.0 cm/s | |
| Precision | @ 4 m bin | | @ 2 m bin | | @ 2 m bin | | @ 2 m bin | | @ 1 m bin | |
| | size | | size | | size | | size | | size | |
| Velocity Range | ±5.0 m/s | | ±5.0 m/s | | ±5.0 m/s | | ±10.0 m/s | | ±5.0 m/s | |
| | (Default); | | (Default); | | (Default); | | (Default); | | (Default); | |
| | ±20.0 m/s | | ±20.0 m/s | | ±20.0 m/s | | ±20.0 m/s | | ±20.0 m/s | |
| | (Maximum) | | (Maximum) | | (Maximum) | | (Maximum) | | (Maximum) | |
| Amplitude Dynamic | 100 | dB | 100 | dB | 100 | dB | 100 | dB | 100 | dB |
| Range | | | | | | | | | | |
| Amplitude | 0.001 | dB | 0.001 | dB | 0.001 | dB | 0.001 | dB | 0.001 | dB |
| Precision | | | | | | | | | | |

Bottom Track:

| | | | | | | | | | | |
|---|---|---|---|---|---|---|---|---|---|---|
| Minimum Altitude | 0.5 | m | 0.3 | m | 0.3 | m | 0.3 | m | 0.3 | m |
| Maximum Altitude | 300 | m | 130 | m | 120 | m | 70 | m | 50 | m |

| | | | | | |
|---|---|---|---|---|---|
| Long-Term | ±0.70% | ±0.25% | ±0.50% | ±0.50% | ±0.25% |
| Accuracy | ±2 mm/s | ±2 mm/s | ±2 mm/s | ±1.5 mm/s | ±2 mm/s |
| Single Ping | 0.6 cm/s | 0.5 cm/s | 0.5 cm/s | 1.5 cm/s | 0.4 cm/s |
| Precision | @ 3 m/s | @ 3 m/s | @ 3 m/s | @ 1.0 m/s | @ 3 m/s |

Data:

| | |
|---|---|
| Communications | [RS-232 & RS-485], [RS-422], [Ethernet (UDP)] |

| | | | | | |
|---|---|---|---|---|---|
| Ping Rate | Up to 10 hz | Up to 10 hz | Up to 10 hz | Up to 10 hz | Up to 10 hz |

| | |
|---|---|
| Internal Recording | 32 GB Micro SD Card |
| Data Formats | RTB, RTD, PD0, PD3, PD4, PD5, PD6, PD13, |
| | MATLAB, CSV, Python |

Sensors:

| | |
|---|---|
| Compass | Range: 0°-360°, Accuracy: 1° RMS, Resolution: 0.01° |
| Pitch/Roll | Range: Roll ±180° \| Pitch ±90°, Accuracy: <1° RMS, |
| | Resolution: 0.01° |
| Water Temp | Range: −5°-70° C., Accuracy: ±0.15° C. |
| Pressure | Range: Selectable, Accuracy: ±0.1% Range |

System:

| Transducer Size | 3 | in | 3 | in | 2 | in | 1 | in | 2 | in |
|---|---|---|---|---|---|---|---|---|---|---|
| Configurations | 4-Beam, 5-Beam, 7-Beam, 8-Beam | | | | | | | | | |
| Beam Width | 2.80° | | 1.42° | | 2.16° | | 3.50° | | 1.01° | |
| Beam Angle | 20° | | 20° | | 20° | | 20° | | 20° | |
| Voltage Range | 12-36 Volt DC | | | | | | | | | |
| Average Power | 23 | W | 30 | W | 30 | W | 30 | W | 23 | W |

| | |
|---|---|
| Temperature | −5° to 45° C. (Operating), −30° to 60° C. (Storage) |
| Depth Rating | 300 m, 3000 m, 4000 m, 6000 m |
| Material Options | Acetal(Plastic), Aluminum, Titanium |

What is claimed is:

1. Acoustic profiling apparatus for use in a fluidic medium, comprising:
at least one first transducer element configured to operate within a first frequency band;
at least one second transducer element configured to operate within a second frequency band different than the first frequency band; and
transmit/receive circuitry in signal communication with the at least one first transducer element and the at least one second transducer element and configured to (i) cause emission of at least a first acoustic beam from the at least one first transducer element and at least a second acoustic beam for the at least one second transducer element; and (ii) enable reception of echoes via at least one of the at least one first and at least one second transducer elements; and
computerized logic in communication with the transmit/receive circuitry and configured to:
determine at least a Doppler frequency shift and an echo intensity relating to each of the acoustic beams; and
compute at least one profile of at least one of parameter related to sediment in the fluidic medium.

2. The acoustic profiling apparatus of claim 1, wherein the computerized logic is further configured to:
determine at least one echo frequency distribution from one or more broadband transmissions centered at each of the first and second frequency bands; and
process the at least one echo frequency distribution from one or more broadband transmissions centered at each of the first and second frequency bands to enable determination of at least one of a particle size distribution or sediment mass.

3. The acoustic profiling apparatus of claim 2, wherein the one or more broadband transmissions each comprise a bandwidth less than 50% of a nominal transmit frequency of the respective first and second frequency bands.

4. The acoustic profiling apparatus of claim 1, further comprising at least one third transducer element, wherein the at least one third transducer element is configured to operate within a third frequency band, the third frequency band different than the first and second frequency bands.

5. The acoustic profiling apparatus of claim 4, wherein the first frequency band comprises a frequency band centered at approximately 600 kHz and the second frequency band comprises a frequency band centered at approximately 1200 kHz, and the third frequency band comprises a frequency band centered at approximately 2400 kHz.

6. The acoustic profiling apparatus of claim 1, wherein the first frequency band comprises a frequency band centered at approximately 600 kHz and the second frequency band comprises a frequency band centered at approximately 1200 kHz.

7. The acoustic profiling apparatus of claim 6, wherein the at least one first transducer element comprises two transducer elements configured to generate respective first and second beams disposed at a prescribed azimuth angle to one another, the respective beams being orthogonal to the at least one acoustic beam of the at least one second transducer element.

8. The acoustic profiling apparatus of claim 7, wherein the generated respective first and second beams disposed at a prescribed azimuth angle to one another comprise first and second beams each having an angular dispersion of approximately 1.5 degrees and a beam centerline oriented substantially normal to a front face of a housing of the acoustic profiling apparatus, and the at least one acoustic beam of the at least one second transducer element comprises a beam having an angular dispersion other than 1.5 degrees and a beam centerline oriented substantially normal to a top face of a housing of the acoustic profiling apparatus.

9. The acoustic profiling apparatus of claim 8, wherein the acoustic profiling apparatus is configured to measure at least one or horizontal currents or sediment mass in the fluidic medium, and the front face of a housing of the acoustic profiling apparatus is configured to be disposed substantially parallel to a plane of a surface of the fluidic medium.

10. The acoustic profiling apparatus of claim 1, wherein the at least one first transducer elements each comprise piston-type transducer elements having a first face diameter, and the at least one second transducer element comprises a piston-type transducer element having a second face diameter smaller than the first diameter.

11. The acoustic profiling apparatus of claim 1, wherein the at least one first transducer elements each comprise at least approximately rectangular transducer elements, and the at least one second transducer element comprises a piston-type transducer element having an at least approximately circular face.

12. A horizontal acoustic profiler apparatus configured to profile a at least one aspect of a body of water, comprising:
a single housing configured to operate within a fluidic medium, the single housing comprising:
a first transducer element configured to form a first acoustic beam oriented in a first direction, the first acoustic beam being associated with a first frequency;
a second transducer elements configured to form a second acoustic beam oriented in a second direction, the second acoustic beam being associated with a second frequency, the second frequency differing from the first frequency,
a third transducer element configured to form a third acoustic beam oriented in a third direction, the third acoustic beam being associated with a third frequency, the third direction being substantially orthogonal to both the first direction and the second direction;
circuitry in signal communication with the first, second and third transducer elements and configured to generate at least the first, second, and third acoustic beams; and
computerized logic in communication with the circuitry and configured to perform Doppler analysis of a plurality of echoes received via the first, second and third transducer elements to enable the horizontal acoustic profiler apparatus to determine both (i) surface height of the body of water relative thereto, and (ii) horizontal current profiles within the body of water.

13. The horizontal acoustic profiler apparatus of claim 12, further comprising at least one pressure sensor configured to generate pressure signals to be used as part of said surface height determination.

14. The horizontal acoustic profiler apparatus of claim 13, further comprising at least one electrical power interface configured to enable powering of the horizontal acoustic profiler apparatus from a remote power source located above the surface of the body of water during operation.

15. The horizontal acoustic profiler apparatus of claim 14, further comprising at least one temperature sensor configured to generate signals related to temperature of water proximate to the horizontal acoustic profiler apparatus to be used as part of a determination by said computerized logic of a speed of sound in the body of water.

16. The horizontal acoustic profiler apparatus of claim 14, further comprising:
at least one pitch/roll sensor configured to generate signals related to an attitude of the horizontal acoustic profiler apparatus relative to a local gravitational field; and
at least one electronic compass apparatus configured to determine at least one azimuth orientation of the horizontal acoustic profiler apparatus.

17. A method of operating an underwater acoustic apparatus having at least first and second acoustic transducers configured to generate acoustic beams at respective ones of first and second frequencies when disposed in a body of water, the method comprising:
generating at least a first acoustic beam at the first frequency from at least the first acoustic transducer;
generating at least a second acoustic beam at a second frequency from at least the second acoustic transducer;
determining a Doppler frequency shift associated with echoes received by the acoustic apparatus relating to the first acoustic beam;
determining a Doppler frequency shift associated with echoes received by the acoustic apparatus relating to the second acoustic beam;
determining an intensity or level of the echoes received by the acoustic apparatus relating to the first acoustic beam;
determining an intensity or level of the echoes received by the acoustic apparatus relating to the second acoustic beam; and
based at least on (i) the determined Doppler frequency shifts associated with the echoes relating to the first and second acoustic beams, and (ii) the determined intensity or level of the echoes relating to the first and second acoustic beams, determining at least one profile of at least a portion of the body of water.

18. The method of claim 17, further comprising:
generating at least one first broadband acoustic transmission within a first frequency band, the first frequency band encompassing the first frequency;
generating at least one second broadband acoustic transmission within a second frequency band, the second frequency band encompassing the second frequency; and
calculating at least one echo frequency distribution based at least on the at least one first broadband acoustic transmission and the at least one second broadband acoustic transmission; and
utilizing the at least one echo distribution to determine at least one of a sediment particle size distribution or a sediment mass.

19. The method of claim 18, wherein the calculating at least one echo frequency distribution based at least on the at least one first broadband acoustic transmission and the at least one second broadband acoustic transmission comprises: (i) calculating at least a first echo frequency distribution based at least on the at least one first broadband acoustic transmission, and (ii) calculating at least a second echo frequency distribution based at least on the at least one second broadband acoustic transmission; and
wherein the utilizing the at least one echo distribution to determine at least one of a sediment particle size distribution or a sediment mass comprises algorithmically combining the at least first echo distribution and the at least second echo distribution.
